(19) United States
(12) Patent Application Publication
(10) Pub. No.: US 2024/0275433 A1
(43) Pub. Date: Aug. 15, 2024

(54) RECONFIGURABLE SURFACE DEVICE, BASE STATION, AND USER EQUIPMENT

(71) Applicant: NTT DOCOMO, INC., Tokyo (JP)

(72) Inventors: Xiang Li, Beijing (CN); Xin Wang, Beijing (CN); Xiaolin Hou, Beijing (CN); Lan Chen, Beijing (CN); Satoshi Suyama, Tokyo (JP)

(73) Assignee: NTT DOCOMO, INC., Tokyo (JP)

(21) Appl. No.: 18/568,135

(22) PCT Filed: Jul. 22, 2021
(86) PCT No.: PCT/CN2021/107861

§ 371 Date: Dec. 7, 2023

(51) Int. Cl. H04B 7/04; H04W 64/00

(52) U.S. Cl. CPC H04B 7/04026; H04W 64/00

(57) ABSTRACT

The present disclosure provides a base station. The base station includes: a control unit configured to determine configuration information regarding a reconfigurable surface device based on location of a user equipment; and a transmitting unit configured to send the configuration information to the reconfigurable surface device so that the reconfigurable surface device determines a codebook used by the reconfigurable surface device based on the configuration information.

### TECHNICAL FIELD

The present disclosure relates to the field of wireless communication, and more particularly relates to a reconfigurable surface device, a base station, and user equipment.

### BACKGROUND

In future communication systems, it is necessary to make high-rate networks cover all kinds of areas. However, the covering capability of wireless systems involving millimeter waves and even higher frequency bands is inadequate and requires further improvement to meet the demands of future communication systems.

Reconfigurable intelligent surface (RIS) technology provides a solution that is potentially of good performance and easy to deploy for solving problems regarding high-rate outdoor coverage. Specifically, RIS can collect signals sent by a signal-transmitting side and transmit them to a signal-receiving side by beamforming. RIS embodies characteristics such as low cost and low power consumption, which provide a brand new possibility for solving problems regarding coverage and capacity of mobile communication systems.

However, in order to achieve high-rate outdoor coverage, usually an RIS panel with a large area (e.g., 1 m×1 m) is needed, so that a large number of users might be located in the near-field range of RIS. As a traditional beamforming solution is designed only for transmission of far-field signals, its near-field performance is not good.

In this regard, there are proposed various solutions to improve the near-field performance of RIS. However, such solutions often involve problems such as unattainable access to information, large loss of near-field performance, poor robustness, difficult application, etc. Therefore, it is necessary to further improve RIS to enhance the performance of RIS.

### SUMMARY

According to an aspect of the present disclosure, there is provided a base station. The base station comprises: a control unit configured to determine configuration information regarding a reconfigurable surface device based on location of a user equipment; and a transmitting unit configured to transmit the configuration information to the reconfigurable surface device so that the reconfigurable surface device determines a codebook used by the reconfigurable surface device based on the configuration information.

For example, the configuration information includes at least one of: information associated with operating mode of the reconfigurable surface device, information associated with default codebook of the reconfigurable surface device, and information associated with how the reconfigurable surface device uses the codebook.

For example, the transmitting unit is further configured to: transmit, to the reconfigurable surface device, control information including information of a time period corresponding to codewords associated with the codebook.

For example, the transmitting unit is further configured to: transmit the configuration information to the reconfigurable surface device through an IP interface or an Xn interface; or transmit the configuration information to the reconfigurable surface device through a wireless interface.

According to another aspect of the present disclosure, there is provided a reconfigurable surface device. The reconfigurable surface device further comprises: a transmitting unit further configured to feed back to the base station a configuration response message indicating configuration successful or configuration failed.

For example, the transmitting unit is further configured to: report information related to type of the reconfigurable surface device to the base station in the RRC procedure, and transmit information required for initial access to the user equipment in the case that the reconfigurable surface device is a base station type. For example, the information required for initial access may include synchronization information and broadcast channel information, such as SSB message, essential system information (SIB), RACH configuration and RACH message, etc.

For example, the configuration information associated with the location of the user equipment is received through a downlink channel, such as DL-SCH, and the configuration response message is sent through an uplink channel, such as UL-SCH.

According to another aspect of the present disclosure, there is provided a user equipment (UE). The UE comprises: a control unit configured to acquire location information of the UE; a transmitting unit configured to transmit the location information to a base station; a receiving unit configured to receive a UE-specific message, wherein the UE-specific message is emitted by the base station to a reconfigurable surface device and reflected/transmitted by the reconfigurable surface device to the UE.

For example, the location information is included in a CSI report transmitted by the user equipment to the base station, wherein the CSI report is at least one of periodic CSI report, semi-periodic CSI report, or semi-static CSI report. Alternatively, the location information is included in the CSI report transmitted by the user equipment to the base station, wherein the CSI report only includes the location information. Alternatively, the location information is included in an RS transmitted by the user equipment to the base station.

In an example according to the present disclosure, parameters of RIS are adaptively adjusted according to user location through a user-location-based adaptive beamforming solution, which reduces loss of near-field performance and enhances signal gain.

### BRIEF DESCRIPTION

The above and other objectives, features, and advantages of the present disclosure will become more apparent by making more detailed descriptions of the embodiments of the present disclosure in conjunction with the accompanying drawings. The accompanying drawings are used to provide a further understanding of the embodiments of the present disclosure and constitute a part of the specification, and together with the embodiments of the present disclosure, serve to explain the present disclosure, and do not constitute a limitation to the present disclosure. In the accompanying drawings, like reference numerals generally represent like parts or steps.

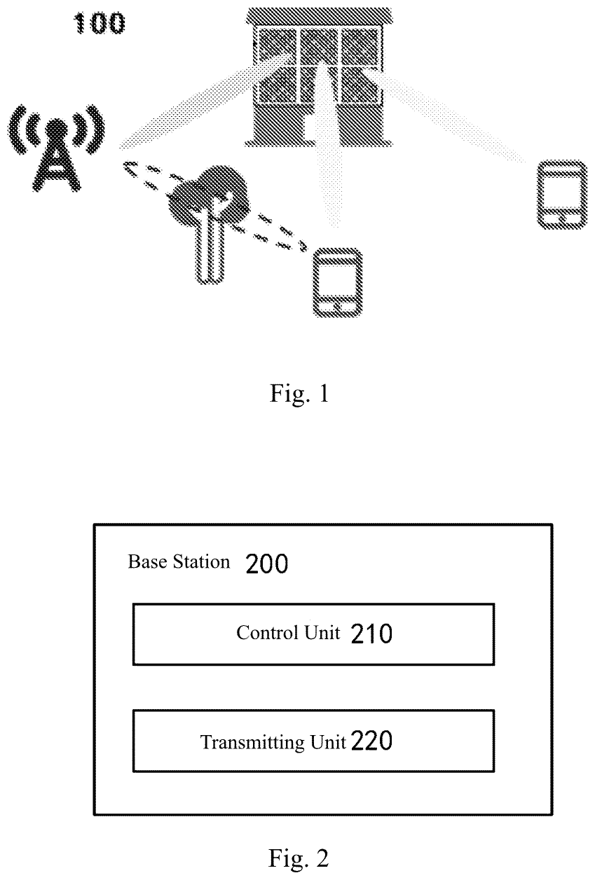

FIG. 1 shows a schematic diagram of a wireless communication system in which the embodiments of the present disclosure may be applied.

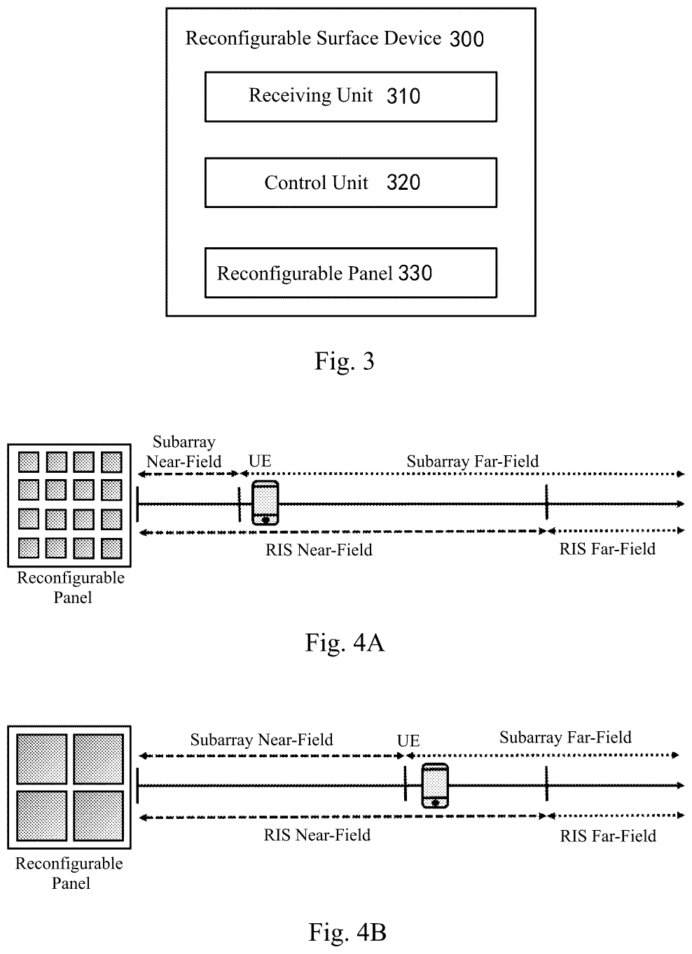

FIG. 2 is a schematic block diagram showing a base station according to an embodiment of the present disclosure.

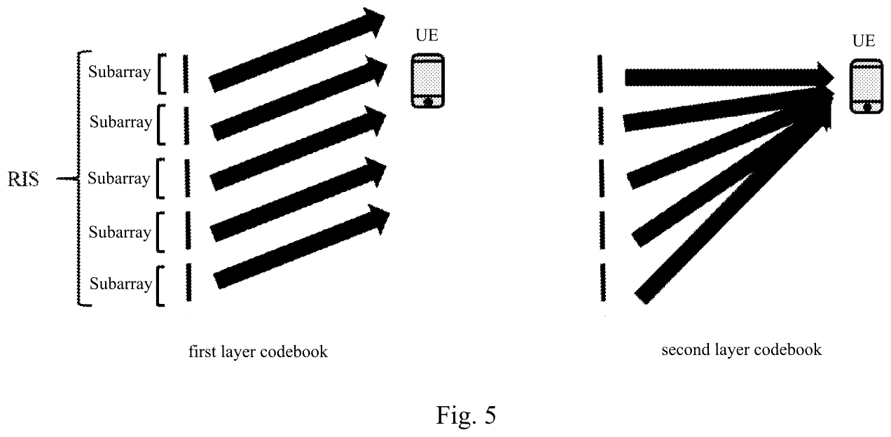

FIG. 3 is a schematic block diagram showing a reconfigurable surface device according to an embodiment of the present disclosure.

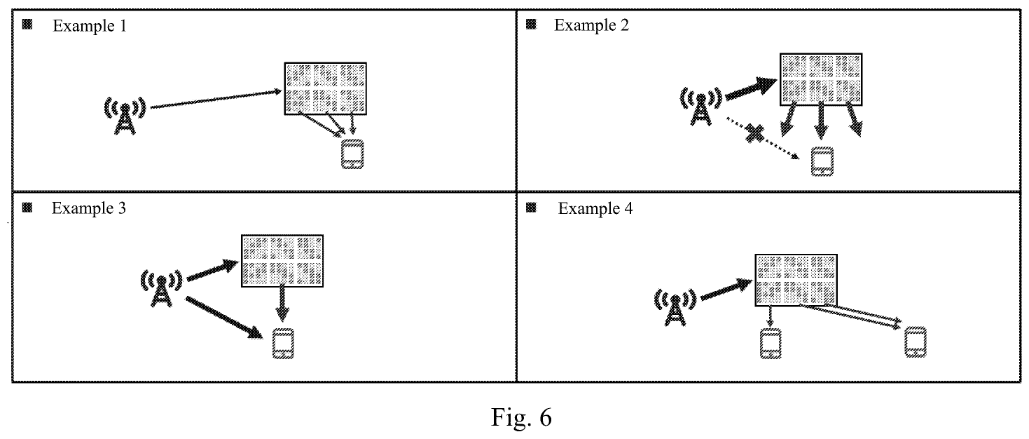

FIG. 4A is an example diagram showing an array element state of a reconfigurable panel of a reconfigurable surface device according to an embodiment of the present disclosure.

FIG. 4B is an example diagram showing another array element state of a reconfigurable panel of a reconfigurable surface device according to an embodiment of the present disclosure.

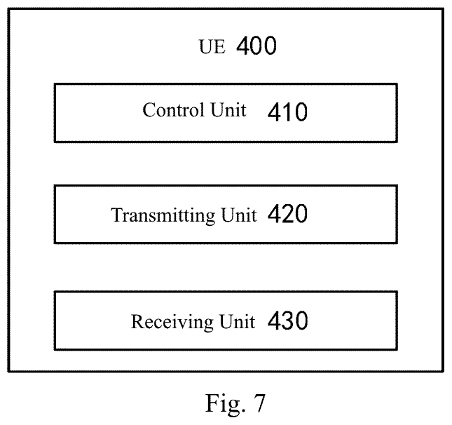

FIG. 5 is yet another example diagram showing an array element state of a reconfigurable panel of a reconfigurable surface device according to an embodiment of the present disclosure.

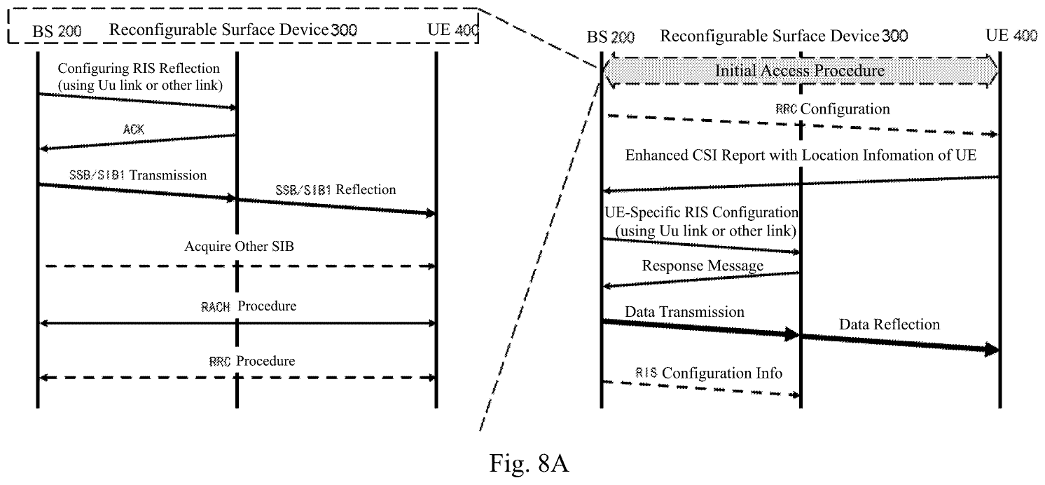

FIG. 6 is yet another example diagram showing an array element state of a reconfigurable panel of a reconfigurable surface device according to an embodiment of the present disclosure.

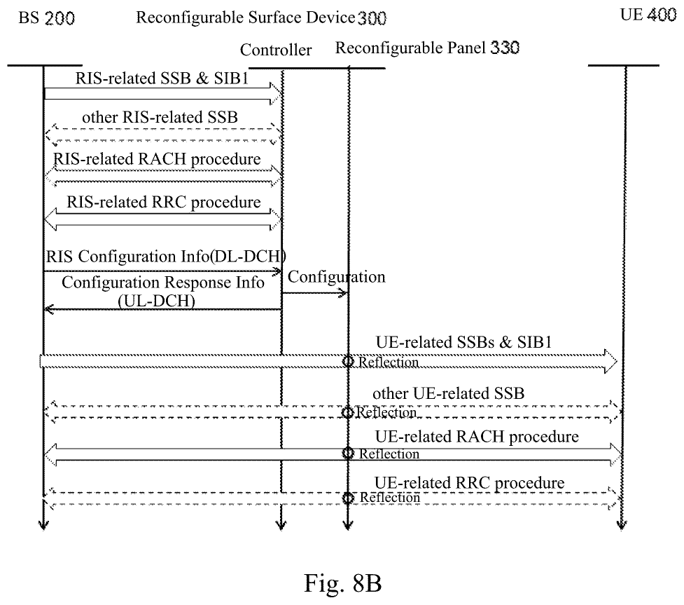

FIG. 7 is a schematic block diagram showing a user equipment according to an embodiment of the present disclosure.

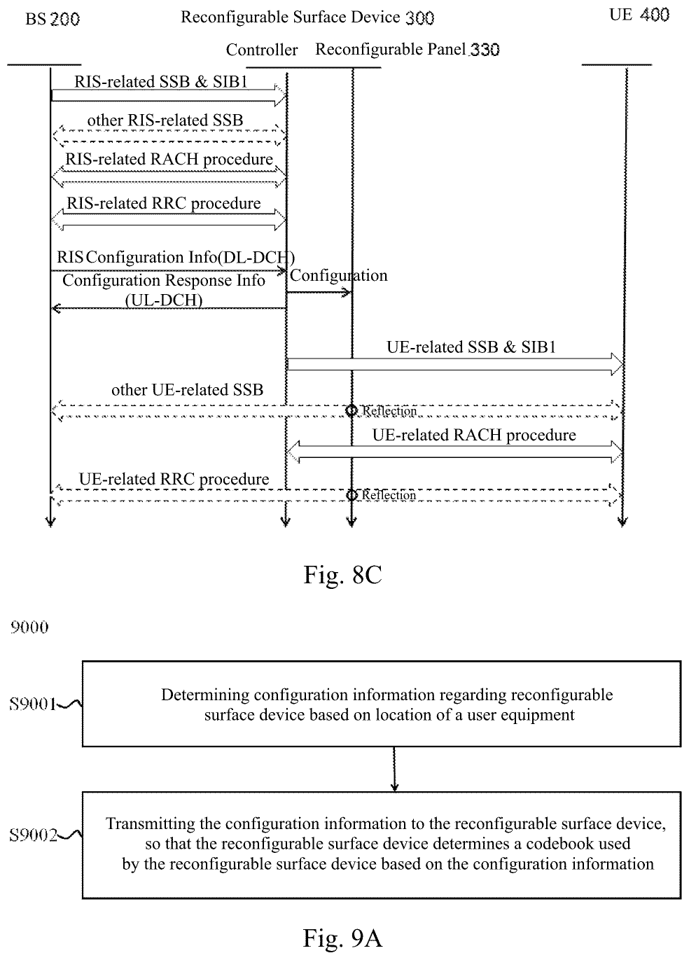

FIG. 8A is an example diagram showing an initial access flow and a RIS beam selection and transmission flow according to an embodiment of the present disclosure.

FIG. 8B is an example diagram showing the signaling interaction of a reconfigurable surface device of a user equipment type in a communication system according to an embodiment of the present disclosure.

FIG. 8C is an example diagram showing the signaling interaction of a reconfigurable surface device of a base station type in a communication system according to an embodiment of the present disclosure.

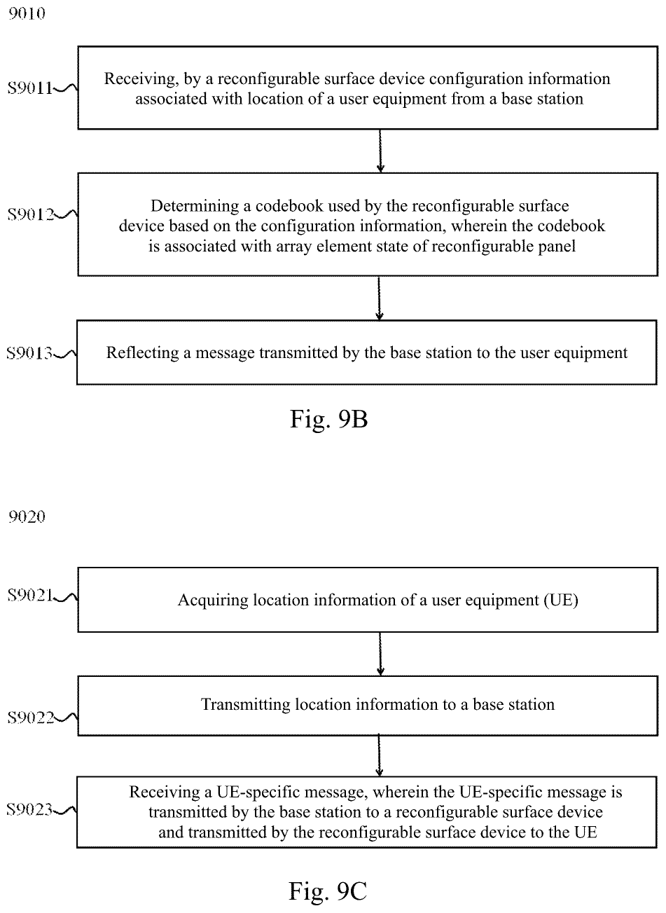

FIG. 9A is an example flowchart showing a method performed by a base station according to an embodiment of the present disclosure.

FIG. 9B is an example flowchart showing a method performed by a reconfigurable surface device according to an embodiment of the present disclosure.

FIG. 9C is an example flowchart showing a method performed by a user equipment according to an embodiment of the present disclosure.

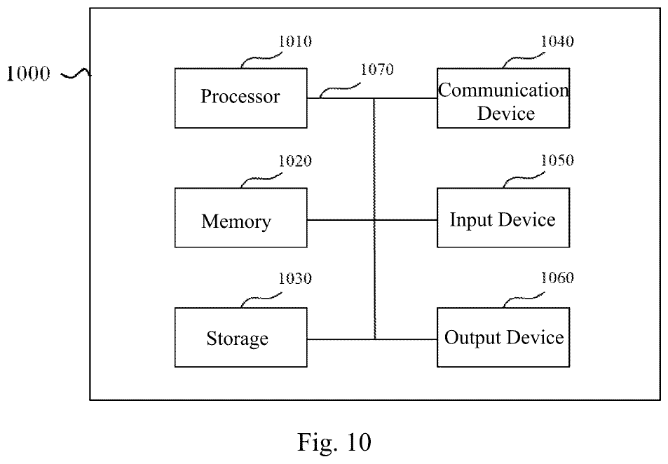

FIG. 10 is a schematic diagram of a hardware structure of an involved equipment according to an embodiment of the present disclosure.

### DETAILED DESCRIPTION

In order to make the objectives, technical solutions, and advantages of the present disclosure more obvious, exemplary embodiments according to the present disclosure will be described in detail below with reference to the accompanying drawings. In the accompanying drawings, like reference numerals refer to like elements throughout. It should be understood that the embodiments described herein are merely illustrative and should not be construed as limiting the scope of the present disclosure.

The present disclosure relates to terminology such as large intelligent surface, intelligent reflecting surface, reconfigurable intelligent surface, passive intelligent surface, reconfigurable metasurface, soft defined surface, soft defined metasurface, large intelligent metasurface, smart reflect array, etc.

Firstly, a communication system in which the embodiments of the present disclosure may be applied will be described with reference to FIG. 1. FIG. 1 shows a schematic diagram of a communication system 100 in which the embodiments of the present disclosure may be applied. The communication system 100 shown in FIG. 1 may be a 5G communication network or a 6G communication network, or any other type of wireless communication network, such as a 4G communication network, etc. Hereinafter, the embodiments of the present disclosure are described by taking a 6G communication network as an example, but it should be recognized that the following description can also be applied to other types of wireless communication networks.

The communication system 100 may include a base station, a reconfigurable surface device, and a user terminal in a 6G communication network. As shown in FIG. 1, communication between the base station and the user terminal might have poor channel quality due to the existence of obstacles. At this time, the reconfigurable surface device can reflect or transmit wireless signals in the environment. For example, with respect to the downlink channel, the base station may transmit the information to be sent to the user equipment to the reconfigurable surface device, and then the reconfigurable surface device can reflect/transmit (i.e. passing through) the information to the user equipment. For another example, with respect to the uplink channel, the user equipment may transmit the information to be transmitted to the base station to the reconfigurable surface device, and then the reconfigurable surface device can reflect/transmit the information to the base station. Therefore, the path loss of the information in the transmission procedure and the adverse effects caused by the obstacles can be reduced. Although in the example shown in FIG. 1, descriptions are made taking the reconfigurable surface device transmitting information to the user through beamforming as an example, it should be understood that the solution of the present disclosure is also applicable to the case in which the base station directly provides a communication link to the user and thus directly communicates with the user equipment.

The reconfigurable surface device shown in FIG. 1 can be either a passive reconfigurable surface (Passive RIS) device or an active reconfigurable surface (Active RIS) device. For example, in the case where the reconfigurable surface device is a passive reconfigurable surface device, the reconfigurable surface device can be deployed in the channel to improve the signal quality of end-to-end (E2E). The reconfigurable surface device deployed in the channel can compensate for the path loss caused by reflection/transmission, adjust the RIS parameters as the channel changes over time, and assist in realizing a full-duplex relay with low delay. In the case that the reconfigurable surface device is an active reconfigurable surface device, the reconfigurable surface device can be deployed on the transmitting side to reduce the cost and power consumption. Since new metamaterials make it possible to integrate a large number of RIS elements to increase the array gain, the active reconfigurable surface device can control the radio signals without traditional PSN and/or RF chains.

For example, channel state information (CSI) at present has been proposed to attempt to solve problems regarding poor near-field performance in current RIS technology. Specifically, in the case that the base station is provided with CSI, the base station may, together with the reconfigurable surface device, jointly determine the beamforming coefficients between the base station and the user equipment as well as the beamforming coefficients between the reconfigurable surface device and the user equipment, and then the base station may inform the reconfigurable surface device of associated beamforming configuration through RIS control link. Since the reconfigurable surface device cannot realize channel estimation based on pilot measurement at present, the current solution is difficult to directly acquire the channel quality information between the base station and the reconfigurable surface device and/or the channel quality information between the reconfigurable surface device and the user equipment, leading to low practicability.

For example, it has been also proposed at present to utilize the traditional DFT-based beam codebook to attempt to solve the above problems. However, since the traditional DFT-based beam codebook is designed for far-field users, the traditional DFT-based beam codebook suffers a larger loss of performance in the near-field.

For example, it has been also proposed at present to utilize reconfigurable surface devices for near-field focusing to attempt to solve problems regarding poor near-field performance in current RIS technology. However, this solution requires that the phases of the RIS array elements be adjusted one by one based on the user's accurate location so as to realize focusing of the signal at the user. Therefore, there are problems such as difficult beam alignment, poor robustness, and difficult application.

As described above, the current solutions often involve unattainable information, large loss of near-field performance, poor robustness, and difficult application. According to the embodiments of the present disclosure, it is desired that the parameters of the RIS can be adaptively adjusted according to the user's location through a user location-based adaptive near-field beamforming solution, thereby reducing the loss of near-field performance and enhancing the signal gain.

Hereinafter, a base station 200 according to an embodiment of the present disclosure will be described with reference to FIG. 2. FIG. 2 is a schematic block diagram showing the base station 200 according to the embodiment of the present disclosure. As shown in FIG. 2, the base station 200 according to the embodiment of the present disclosure may include a control unit 210 and a transmitting unit 220. In addition to the control unit and the transmitting unit, the base station 200 may further include other components, however, since these components have nothing to do with the contents of the embodiments of the present disclosure, their illustrations and descriptions are omitted here.

As shown in FIG. 2, the control unit 210 may be configured to determine configuration information regarding a reconfigurable surface device based on the location of a user equipment. The transmitting unit 220 may be configured to transmit the configuration information to the reconfigurable surface device, so that the reconfigurable surface device determines a codebook used by the reconfigurable surface device based on the configuration information.

For example, the configuration information may indicate the location of the user equipment in an explicit or implicit way. For example, the configuration information may include geographic coordinates (e.g., 3D coordinates) of the user equipment, or a distance of the user equipment from the reconfigurable surface device, or a direction of the user equipment relative to the reconfigurable surface device, and so on. Optionally, the location of the user equipment may be the relative location of the user equipment with respect to the reconfigurable surface device. For another example, the configuration information may further indicate the location of the user equipment in a distance-quantizing manner. Specifically, the configuration information may indicate whether the user equipment is within the near-field range of the reconfigurable surface device with different bits. For example, the above near-field range may be determined according to the specific configuration of the communication system. It should be understood by those skilled in the art that the present disclosure is not limited thereto.

For example, the codebook used by the reconfigurable surface device may be further calculated based on quantized parameters. The quantized parameter may be a logarithmically quantized distance between the user equipment and the reconfigurable surface device. The quantized parameters may be packaged into binary vectors and used as indicators of codewords of the codebook.

For example, the codebook used by the reconfigurable surface device is associated with the array element state of the reconfigurable panel. Optionally, the array element state of the reconfigurable panel may be the subarray area, number of subarrays, subarray beam deflection, and/or the like for the reconfigurable panel. For example, the subarray area is positively correlated with the gain and the near-field range of the reconfigurable panel. The number of subarrays is also positively correlated with the gain of the reconfigurable panel. The mode and the direction of the subarray beam deflection are related to the coverage range of the reconfigurable panel. Therefore, adjusting the codebook based on the location information of the user equipment and thus adjusting the array element state of the reconfigurable panel will be beneficial to reducing the influence on the near-field user equipment, increasing the signal gain, and adjusting the signal coverage range. Thereafter, how the reconfigurable surface device determines the codebook used by the reconfigurable surface device based on the configuration information (or the location of the user equipment) will be described with reference to FIGS. 4 to 6, which will not be detailed here.

Optionally, the configuration information may further include at least one of: information associated with operating mode of the reconfigurable surface device, information associated with the codebook of the reconfigurable surface device, and information associated with how the reconfigurable surface device uses the codebook.

For example, the information associated with the operating mode of the reconfigurable surface device may indicate whether the reconfigurable surface device is operated dynamically, statically or semi-statically. Alternatively, the information associated with the operating mode of the reconfigurable surface device may further indicate whether the reconfigurable surface device changes its operating mode, for example, from being operated dynamically to being operated statically/being operated semi-statically, or from being operated statically/being operated semi-statically to being operated dynamically, and so on. For example, if the reconfigurable surface device is operated dynamically, it may dynamically adjust the codewords it uses according to a dynamic codeword switching message received from the base station or the user equipment, so as to improve the quality of communication link. Alternatively, in some embodiments, the reconfigurable surface device may also dynamically adjust the codebook it uses according to a dynamic codebook switching message received from the base station or the user equipment. The present disclosure does not limit the operating mode of the reconfigurable surface device.

For example, the information associated with the codebook of the reconfigurable surface device may indicate a quantization resolution of the codebook. Optionally, the quantization resolution of the codebook may be associated with a (logarithmically) quantized distance between the user equipment and the reconfigurable surface device, and the present disclosure does not limit how to design the quantization resolution of the codebook. For another example, the information associated with the codebook of the reconfigurable surface device may further indicate a default codebook used by the reconfigurable surface device. For example, the default codebook may be the initial codebook used by the reconfigurable surface device.

For example, the information associated with how the reconfigurable surface device uses the codebook may indicate how to use the default codebook. For example, in the case that the reconfigurable surface device does not receive the codebook switching message, the base station may utilize the configuration information to instruct the reconfigurable surface device to use the default codebook or continue to use the most lately used codebook. Furthermore, alternatively, the information associated with how the reconfigurable surface device uses the codebook may further indicate how to use default codewords. For example, in the case that the reconfigurable surface device does not receive the codeword switching message, the base station may utilize the configuration information to instruct the reconfigurable surface device to use the default codewords or continue to use the most lately used codeword.

For example, the transmitting unit is further configured to transmit to the reconfigurable surface device control information including information of a time period corresponding to codewords associated with the codebook. Optionally, the time period is in units of slot. It should be understood by those skilled in the art that the time period can also be in units of subframes, mini-slots, and/or the like, which is not limited by the present disclosure. Optionally, the control information may instruct the reconfigurable surface device to use a time slot of a certain codeword. Optionally, the control information may further instruct the reconfigurable surface device to use a codeword sequence in multiple consecutive time slots. Alternatively, the control information may further instruct the reconfigurable surface device to use the starting time slot, ending time slot, and/or the like of a certain codeword. Alternatively, the control information may further instruct the reconfigurable surface device to use a certain codeword every a few time slots, or to use a certain codeword constantly until a codeword switching command is received, and so on.

For example, the transmitting unit may be further configured to transmit the configuration information (or control information) to the reconfigurable surface device through a wired IP network interface such as Internet network or an interface between base stations such as Xn. Alternatively, the transmitting unit may be further configured to transmit the configuration information (or control information) to the reconfigurable surface device through a wireless interface. In this case, the reconfigurable surface device may be provided with a module related to the Internet of Things user terminal to receive the above configuration information or control information through the air interface.

In addition, the base station may also transmit other information related to the user equipment to the reconfigurable surface device so that the reconfigurable surface device determines the codebook/codeword, such as the moving speed of the user equipment, whether it is located at the edge of the coverage range of the base station, whether there are other user equipment in the vicinity of the user equipment, and so on, which is not limited by the present disclosure.

Therefore, in the above examples according to the present disclosure, the reconfigurable surface device can adaptively adjust the parameters of the RIS (e.g., the codebook or codewords it uses) according to the location of the user by transmitting the configuration information related to the location of the user equipment to the reconfigurable surface device, thereby being able to reduce the loss of near-field performance and enhance the signal gain.

Hereinafter, a reconfigurable surface device 300 according to an embodiment of the present disclosure will be described with reference to FIG. 3. FIG. 3 is a schematic block diagram showing the reconfigurable surface device 300 according to the embodiment of the present disclosure. As shown in FIG. 3, the reconfigurable surface device 300 according to the embodiment of the present disclosure may include a receiving unit 310, a control unit 320, and a reconfigurable panel 330. In addition to the receiving unit, the control unit, and the reconfigurable panel, the reconfigurable surface device 300 may further include other components, which will not be detailed here.

As shown in FIG. 3, the receiving unit 310 is configured to receive configuration information associated with the location of the user equipment from the base station. The control unit 320 is configured to determine, based on the configuration information, a codebook used by the reconfigurable surface device, which is associated with an array element state of the reconfigurable panel. The reconfigurable panel 330 is configured to reflect/transmit, to the user equipment, a message sent by the base station to the user equipment.

Optionally, the reconfigurable surface device further includes a transmitting unit. The transmitting unit may be configured to feed back to the base station a configuration response message indicating configuration success or configuration failure. Optionally, the transmitting unit may be further configured to report information related to the type of the reconfigurable surface device to the base station in the RRC procedure. For example, the information related to the type of the reconfigurable surface device may indicate whether the reconfigurable surface device is a user equipment type or a base station type. Different types of reconfigurable surface devices can correspond to different signaling interaction processes and different signal transmission interfaces.

For example, in the case that the reconfigurable surface device is a base station type, the transmitting unit may be further configured to transmit, to the user equipment, an SSB message, an SIB message, and a message related to RACH, for the user equipment. Optionally, the configuration information associated with the location of the user equipment may be received through a downlink channel, such as Downlink Shared Channel (DL-SCH), and the configuration response message may be sent through an uplink channel, such as Uplink Shared Channel (UL-SCH). Thereafter, the interaction of associated messages will be described with reference to FIGS. 8A to 8C, which will not be detailed here.

Optionally, the array element state of the reconfigurable panel may be subarray area, number of subarrays, subarray beam deflection, and/or the like for the reconfigurable panel, so that the reconfigurable panel is adjusted to enable it to reduce the loss of near-field performance, make up for the path loss in the communication link, adjust the communication coverage, and so on.

Hereinafter, a method for determining a codebook by the reconfigurable surface device 300 according to an embodiment of the present disclosure will be described with reference to FIGS. 4A to 6. FIG. 4A is an example diagram showing an array element state of a reconfigurable panel of the reconfigurable surface device 300 according to an embodiment of the present disclosure. FIG. 4B is an example diagram showing yet another array element state of the reconfigurable panel of the reconfigurable surface device 300 according to an embodiment of the present disclosure. FIG. 5 is another example diagram showing the array element state of the reconfigurable panel of the reconfigurable surface device 300 according to an embodiment of the present disclosure. FIG. 6 is still another example diagram showing the array element state of the reconfigurable panel of the reconfigurable surface device 300 according to an embodiment of the present disclosure.

As described above, the array element state of the reconfigurable panel may include dividing mode of subarrays and beam deflection mode of subarrays for the reconfigurable panel. The dividing modes of subarrays and beam deflection modes of subarrays corresponding to the reconfigurable panel for locations of different user equipment will be described with reference to FIGS. 4A, 4B, and 5.

As shown in FIG. 4A, FIG. 4B, and FIG. 5, the reconfigurable surface device may use different codebooks/codewords based on the locations of different user equipment, and the codebooks/codewords used by the reconfigurable surface device are related to the dividing modes of subarrays and beam deflection modes of subarrays for the reconfigurable panel of the reconfigurable surface device. Optionally, the reconfigurable surface device may set a two-layer codebook according to the configuration information associated with the location of the user equipment received from the base station. Among them, a first layer codebook relates to subarray area, number of subarrays, and reference beam, and a second layer codebook relates to beam deflection. That is, the first layer codebook is a kind of intra-subarray codebook and the second layer codebook is a kind of inter-subarray codebook.

Specifically, the smaller the distance between the reconfigurable surface device and the user equipment is, the smaller the size of the subarrays into which the reconfigurable panel can be divided. The smaller the subarray area for the reconfigurable panel is, the smaller the near-field range of the subarrays for the reconfigurable panel is, and thus the smaller the near-field loss is.

For example, referring to FIG. 4A, in the case that the user equipment is close to the reconfigurable panel, the reconfigurable panel of the reconfigurable surface device can be divided into 16 subarrays. At this time, the area of each subarray is small, and the near-field range formed by each subarray is also small. In this case, even if the user equipment is located near the reconfigurable panel, each subarray is still located in the far-field of the subarray. In other words, if the configuration information indicates that the user equipment is close to the reconfigurable panel, the reconfigurable surface device may determine the codebook corresponding to the subarrays with smaller areas into which the reconfigurable panel is divided, thereby reducing the influence of the near-field of the user equipment.

FIG. 5 gives an example in which the reconfigurable surface device selects 5 subarrays from the 16 subarrays in FIG. 4A to serve the user equipment based on configuration information. Those skilled in the art should understand that FIG. 5 and FIG. 4A are only examples. In fact, based on the configuration information, the reconfigurable panel is divided into M subarrays, and N subarrays from the M subarrays may be used to serve a single user equipment, where M is a positive integer greater than 1, and N is a positive integer greater than 1 and less than or equal to M. Optionally, each of the M subarrays, into which the reconfigurable panel is divided, corresponds to a specific beam, respectively. A specific beam may also be a beam emitted from a corresponding subarray.

With continued reference to FIG. 5, the configuration information may further indicate the direction of the user equipment relative to the reconfigurable panel, and thus the first layer codebook may further contain information related to the reference beams of respective subarrays. For the respective subarrays, the reference beams are the same.

In some cases, in order to improve the signal gain, the reconfigurable surface device may deflect respective specific beams of N subarrays from the M subarrays relative to the reference beams by setting the second layer codebook, so that the specific beams can converge at the user equipment. FIG. 5 gives an example in which the specific beams of 5 subarrays from the 16 subarrays in FIG. 4A converge at the user equipment by utilizing the second layer codebook. Therefore, the reconfigurable surface device may further determine the second layer codebook according to the configuration information, so as to configure the reflected/transmitted beams of each subarray (that is, the specific beams of each subarray) for deflection. Since the directions of the connecting lines between the user equipment and the center points of the respective subarrays relative to the above reference beams are different, and the deflecting direction of the specific beams of each subarray are also different, the second layer codebook set according to the configuration information may be specific to each subarray, so that the beams of each subarray converge at the user equipment after deflection.

In addition, referring to FIG. 4B, in the case that the user equipment is far away from the reconfigurable panel, the reconfigurable panel of the reconfigurable surface device can be divided into 4 subarrays. The area of each subarray is large, and the near-field range formed by each subarray is also large. In this case, even if the user equipment is still in the near-field range of the reconfigurable panel, the user equipment is in the far-field of the subarray. In other words, if the configuration information indicates that the user equipment is far away from the reconfigurable panel, the reconfigurable surface device may determine the codebook corresponding to the subarrays with larger areas into which the reconfigurable panel is divided. Since the distance between the user equipment and the reconfigurable panel is large, even the subarrays with larger areas will not cause an obvious near-field influence on the user equipment.

Table 1 and Table 2 below show a relationship between near-field range of subarray and subarray area for the reconfigurable surface device, taking Rayleigh distance as an example, in the case of signals of 3 GHz and 30 GHz respectively.

TABLE 1

| | | | |
|---|---|---|---|
| Subarray Area | 0.5 m × 0.5 m | 1 m × 1 m | 5 m × 5 m |
| Near-field range of 3 GHz signal | 2.5 m | 10 m | 250 m |

TABLE 2

| | | | |
|---|---|---|---|
| Subarray Area | 0.25 m × 0.25 m | 0.5 m × 0.5 m | 1 m × 1 m |
| Near-field range of 30 GHz signal | 6 m | 25 m | 100 m |

Therefore, the reconfigurable surface device may determine the codebook used by the reconfigurable surface device according to the configuration information associated with the location of the user equipment received from the base station, so as to adjust the array element state of the reconfigurable panel according to the codebook, such as subarray area, number of subarrays, subarray beam deflection, and/or the like for the reconfigurable panel. Therefore, the reconfigurable surface device can reduce the loss of near-field performance and enhance the signal gain.

Optionally, as shown in FIG. 6, the reconfigurable surface device may further adjust the array element state to serve the user equipment in different scenarios.

For example, referring to Example 1, the configuration information may further indicate that the user equipment is located at the edge of the coverage range of the base station, or further indicate that the signal transmission rate of the current user equipment is low. In this case, the reconfigurable surface device may determine to use multiple subarrays to serve the user equipment, and the reflected beams or transmitted beams of the multiple subarrays may be focused on the user equipment to improve the signal quality. If the distance between the user equipment and the reconfigurable surface device is close, multiple smaller subarrays may be used to serve the user equipment to further improve the signal quality.

For example, referring to Example 2, the configuration information may further indicate that the user equipment is in a moving state, or there is an occlusion in the transmission path between the base station and the user equipment. In such case, the reconfigurable surface device may also determine to use multiple subarrays to serve the user equipment, and the beams of respective subarrays from the multiple subarrays may not be focused at the same location, so that the beams reflected/transmitted by the reconfigurable surface device can cover a larger range, thereby enabling the user equipment to receive stable signals robustly in this case. Optionally, the codebook determined at this time may indicate that the size of the area of the subarray is moderate, so as to cover a larger range.

For example, referring to Example 3, in the case that there are both a base station-user equipment communication link and a base station-reconfigurable surface device-user equipment communication link, the configuration information may further indicate that the base station-reconfigurable surface device-user equipment communication link is complementary to/multiplexed with the base station-user equipment communication link. In this case, the reconfigurable surface device may also determine a codebook which indicates a selection of a medium-sized or small-sized subarray area to increase the multiplexing gain. Optionally, in this case, multiple subarrays may also be used to serve the user equipment. The codewords/codebooks used by the multiple subarrays may be different, so that the signal gains of both the base station-reconfigurable surface device communication path and the reconfigurable surface device-user equipment communication path can be balanced, so as to enhance the signal gain.

For example, referring to Example 4, in the case that the same reconfigurable surface device serves multiple user equipment, different subarray areas and numbers of subarrays may be configured for different users based on the locations of different user equipment. At this time, orthogonal multiplexing (time division, or frequency division) waveforms or non-orthogonal (NOMA) waveforms may also be used to balance the signal gain between respective user equipment.

For the above four different example scenarios, the reconfigurable surface device may determine the codebooks/codewords according to the configuration information associated with location of the user equipment. In addition, the reconfigurable surface device may also determine the codebooks/codewords according to other information of the user equipment, such as the moving speed of the user equipment, whether it is located at the edge of the coverage range of the base station, whether there are other user equipment in the vicinity of the user equipment, and/or the like, which is not limited by the present disclosure.

Hereinafter, a user equipment 400 according to an embodiment of the present disclosure will be described with reference to FIG. 7. FIG. 7 is a schematic block diagram showing the user equipment 400 according to the embodiment of the present disclosure. As shown in FIG. 7, a reconfigurable surface device 400 according to the embodiment of the present disclosure may include a control unit 410, a transmitting unit 420 and a receiving unit 430. In addition to the control unit 410, the transmitting unit 420 and the receiving unit 430, the user equipment 400 may further include other components, which will not be detailed here.

As shown in FIG. 7, the control unit 410 is configured to acquire location information of the user equipment. The transmitting unit 420 is configured to transmit the location information to a base station. The receiving unit 430 is configured to receive a message specific to the user equipment (i.e. UE-specific message). Wherein the message specific to the user equipment is emitted by the base station to the reconfigurable surface device and reflected/transmitted by the reconfigurable surface device to the user equipment.

As described above, the base station 200 needs to determine the configuration information regarding the reconfigurable surface device 300 based on the location of the user equipment 400. To this regard, an enhanced CSI inclusion is provided to realize additional reporting of location of user equipment 400, so as to facilitate the base station 200 to determine the configuration information and the reconfigurable surface device 300 to determine the codebook.

For example, the location information may be included in a CSI report transmitted by the user equipment to the base station, and the CSI report is at least one of periodic CSI report, semi-periodic CSI report or semi-static CSI report. The CSI report may further include various other information, such as channel quality information between the reconfigurable surface device and the user equipment detected by the user equipment, and/or the like, which is not limited by the present disclosure.

Alternatively, a new CSI feedback report may be defined. The location information may also be included in a CSI report transmitted by the user equipment to the base station, and the CSI report only includes the location information.

Alternatively, the location information may also be included in a reference signal (RS) transmitted by the user equipment to the base station. For example, the reference signal is used for the base station to measure/estimate the location of the user equipment. Alternatively, the reference signal is used for the base station to measure/estimate the location of the user equipment with the assistance of the reconfigurable surface device 300.

Therefore, by means of the user equipment 400 according to the embodiment of the present disclosure, the base station 200 can conveniently acquire the location information of the user equipment 400, so as to realize the subsequent determination of the configuration information and/or the codebook.

Hereinafter, an example interaction procedure of a base station, a reconfigurable surface device and a user equipment in a communication system according to the embodiments of the present disclosure will be described with reference to FIGS. 8A to 8C. FIG. 8A is an example diagram showing an initial access flow and a RIS beam selection and transmission flow according to an embodiment of the present disclosure. FIG. 8B is an example diagram showing the signaling interaction of the reconfigurable surface device 300 of a user equipment type in the communication system 100 according to an embodiment of the present disclosure. FIG. 8C is an example diagram showing the signaling interaction of the reconfigurable surface device 300 of a base station type in the communication system 100 according to an embodiment of the present disclosure.

As shown in FIG. 8A, in the initial access flow, the transmitting module 220 of the base station 200 may transmit configuration information to the reconfigurable surface device 300 through Uu link or some other link. The configuration information here may be non-UE-specific configuration information, which optionally includes information associated with operating mode of the reconfigurable surface device 300, information associated with codebook of the reconfigurable surface device 300, information associated with how the reconfigurable surface device 300 uses the codebook, etc. Of course, the configuration information here may also be the configuration information specific to the user equipment, which is not limited by the present disclosure.

Next, the transmitting unit of the reconfigurable surface device 300 is further configured to feed back to the base station 200 a configuration response message (ACK) indicating a configuration success or a configuration failure. After the base station 200 receives the configuration response message, the base station 200 may transmit SSB or SSB1 information to the reconfigurable surface device 300, and then the reconfigurable surface device 300 may reflect/transmit the SSB or SSB1 information to the user equipment 400. Optionally, the base station 200 may also transmit other SIB information through other communication links between it and the user equipment 400, for example, the base station 200 may transmit such SIB information by means of broadcasting.

Thereafter, the base station 200 and the user equipment 400 will complete the RACH procedure in the initial access flow, and optionally perform the RRC procedure. Therefore, the procedure of the reconfigurable surface device 300 and the user equipment 400 initially accessing to the base station 200 is completed, and all of the three may communicate through the established communication link.

After the initial access flow is completed, the subsequent data transmission flow may be carried out. Specifically, in some cases, the user equipment 400 might move in the area covered by the base station 200, or be located in the near-field range of the reconfigurable surface device 300. The codebooks and/or codewords configured by the reconfigurable surface device 300 in the initial access flow may need to be further adjusted to improve the signal gain and the near-field performance.

After the initial access procedure between the base station 200 and the user equipment 400 ends, the base station 200 may optionally further configure the user equipment 400 by utilizing the RRC configuration procedure. For example, if there is an obstacle in the communication link between the user equipment 400 and the base station 200 and further signal enhancement by the reconfigurable surface device 300 is required, then the base station 300 may configure the user equipment 400 to report the location information. In FIG. 8A, the base station 300 configures the user equipment 400 to report the location of the user equipment through an enhanced CSI report. Optionally, the enhanced CSI report only includes the location of the user equipment. Of course, the base station 300 may further configure the user equipment 400 to report the user location in other ways. For example, the base station may further configure the user equipment 400 to perform periodic CSI reports, semi-periodic CSI reports or semi-static CSI reports, etc., or configure the user equipment 400 to transmit reference messages for measuring the location of the user equipment, etc. The present disclosure is not limited thereto.

After base station 200 receives the enhanced CSI report with the location information of the user equipment, base station 200 may transmit the configuration information and control information specific to the user equipment 400 (i.e. UE-specific control information) to the reconfigurable surface device 300 in the manner described in FIG. 2. For example, the configuration information and control information specific to the user equipment 400 may be sent through a UU link or some other link. Optionally, the reconfigurable surface device 300 may also receive the configuration information associated with the location of the user equipment through DL-SCH. Optionally, the reconfigurable surface device 300 may also transmit the configuration response message through UL-SCH.

Thereafter, the base station 200 may transmit data specific to the user equipment 400 to the reconfigurable surface device 300, and the reconfigurable surface device 300 may reflect/transmit the data specific to the user equipment 400 by utilizing its reconfigurable panel 330. Optionally, if the location of the user equipment 400 changes, the base station 200 may transmit a codeword switching command to the reconfigurable surface device 300 to make the reconfigurable surface device 300 adjust the array element state of the reconfigurable panel 330.

Optionally, the transmitting unit of the reconfigurable surface device 300 is further configured to report information related to type of the reconfigurable surface device to the base station in the RRC procedure. Optionally, the information related to the type of the reconfigurable surface device may indicate whether the type of the reconfigurable surface device is a base station type or a user equipment type. Next, the signaling interaction procedure of the reconfigurable surface device 300 of the user equipment type in the communication system 100 will be described with reference to FIG. 8B, and the signaling interaction procedure of the reconfigurable surface device 300 of the base station type in the communication system 100 will be described with reference to FIG. 8C.

Referring to FIG. 8B, a combination of the receiving unit 310, the control unit 320 and the transmitting unit in the reconfigurable surface device 300 is drawn as a controller. The controller is used to interact with the base station-side in the RRC procedure. The controller in FIG. 8B may be regarded as a new type of user-side node. The transmission of SSB and SIB1 information related to RIS and other SIB information, the RACH procedure, and the RRC procedure, drawn in FIG. 8B are similar to the corresponding transmission procedures in the initial access flow in FIG. 8A, which will not be detailed here.

After the initial access flow ends, the base station 200 transmits the configuration information associated with the location of the user equipment 400 to the reconfigurable surface device 300 through DL-SCH. The receiving unit 310 in the controller receives the configuration information. The control unit 320 in the controller determines the codebook used by the reconfigurable panel 330 according to the configuration information, or selects appropriate codewords from the default codebook and configures the reconfigurable panel 330 according thereto.

Next, the transmitting unit in the controller transmits through UL-SCH configuration response information indicating a configuration success or a configuration failure. Thereafter, the reconfigurable panel 330 reflects/transmits various information from the base station to the user equipment 400. Such information includes SSB messages, SIB messages, RACH procedure-related messages, RRC procedure-related messages, and/or the like for the user equipment.

Referring to FIG. 8C, a combination of the receiving unit 310, the control unit 320 and the transmitting unit in the reconfigurable surface device 300 is drawn as a controller. The controller is used to interact with the base station in the RRC procedure. The controller in FIG. 8C may be regarded as a new type of base station-side node, for example, a new type of integrated radio access and backhaul (IAB) node. In general, an IAB node may be used to process and transmit various types of messages and information, for example, SSB-related messages, SIB1-related messages, other SIB messages, RACH procedure-related messages, RRC procedure-related messages, and so on. However, the controller in FIG. 8C can only be used to process SSB procedure-related messages and RACH procedure-related messages. Therefore, to be further, the controller in FIG. 8C may be regarded as a simplified IAB node. Of course, the controller in FIG. 8C may also process other procedure-related messages, which is not limited by the present disclosure.

The transmission of SSB and SIB1 information related to RIS and other SIB information, the RACH procedure, and the RRC procedure, drawn in FIG. 8C, are similar to the corresponding transmission procedures in the initial access flow in FIG. 8A, which will not be detailed here. After the initial access flow ends, the base station 200 transmits the configuration information associated with the location of the user equipment 400 to the reconfigurable surface device 300 through DL-SCH. The receiving unit 310 in the controller receives the configuration information. The control unit 320 in the controller determines the codebook used by the reconfigurable panel 330 according to the configuration information, or selects appropriate codewords from the default codebook and configures the reconfigurable panel 330 according thereto.

Next, the transmitting unit in the controller transmits through UL-SCH configuration response information indicating a configuration success or a configuration failure. Thereafter, the controller may transmit information required for initial access to the user equipment. For example, the information required for initial access may include synchronization information and broadcast channel information, such as SSB messages, essential system information (SIB) messages, RACH configuration and RACH messages, and so on. The reconfigurable panel 330 may reflect/transmit the above messages and/or the like to the user equipment.

Therefore, according to the embodiments of the present disclosure, the parameters of the RIS can be adaptively adjusted according to the user's location through the user location based adaptive near-field beamforming solution, thereby reducing the loss of near-field performance and enhancing the signal gain.

Hereinafter, various methods according to embodiments of the present disclosure will be described with reference to FIGS. 9A to 9C.

FIG. 9A is a flowchart of method 9000 performed by a base station according to an embodiment of the present disclosure. Since the steps of method 9000 performed by the base station correspond to the operations of base station 200 described above with reference to the drawings, a detailed description of the same content is omitted here for the sake of simplicity.

As shown in FIG. 9A, in step S9001, a base station determines configuration information regarding reconfigurable surface device based on location of the user equipment. Then in step S9002, the base station transmits the configuration information to the reconfigurable surface device, so that the reconfigurable surface device determines a codebook used by the reconfigurable surface device based on the configuration information. For example, the base station may also transmit to the reconfigurable surface device control information including information of a time period corresponding to codewords associated with the codebook.

For example, the configuration information further includes at least one of: information associated with operating mode of the reconfigurable surface device, information associated with codebook of the reconfigurable surface device, and information associated with how the reconfigurable surface device uses the codebook. For example, the configuration information may be sent to the reconfigurable surface device through an IP interface or an Xn interface, or the configuration information may be sent to the reconfigurable surface device through a wireless interface.

FIG. 9B is a flowchart of a method 9010 performed by a reconfigurable surface device according to an embodiment of the present disclosure. Since the steps of the method 9010 performed by the reconfigurable surface device correspond to the operations of the reconfigurable surface device 300 described above with reference to the drawings, a detailed description of the same content is omitted here for the sake of simplicity.

As shown in FIG. 9B, in step S9011, a reconfigurable surface device receives configuration information associated with location of a user equipment from a base station. Then in step S9012, a codebook used by the reconfigurable surface device is determined based on the configuration information, and the codebook is associated with array element state of reconfigurable panel. Next in step S9013, the user equipment reflects/transmits a message sent by the base station to the user equipment.

For example, the reconfigurable surface device also feeds back to the base station a configuration response message indicating a configuration success or a configuration failure. Optionally, the reconfigurable surface device also reports information related to type of the reconfigurable surface device to the base station in the RRC procedure. In the case that the reconfigurable surface device is a base station type, the reconfigurable surface device transmits, to the user equipment, SSB messages, SIB messages and messages related to RACH, for the user equipment. Optionally, the configuration information associated with the location of the user equipment is received through DL-SCH, and the configuration response message is sent through UL-SCH.

FIG. 9C is a flowchart of method 9020 performed by a user equipment according to an embodiment of the present disclosure. Since the steps of method 9020 performed by the user equipment correspond to the operations of the user equipment 400 described above with reference to the drawings, a detailed description of the same content is omitted here for the sake of simplicity.

As shown in FIG. 9C, in step S9021, a user equipment acquires location information of a user equipment. Then in step S9022, the location information is sent to a base station. Next in step S9023, a message specific to the user equipment (i.e. UE-specific message) is received. Wherein the message specific to the user equipment is emitted by the base station to a reconfigurable surface device and reflected/transmitted by the reconfigurable surface device to the user equipment.

For example, the location information is included in a CSI report transmitted by the user equipment to the base station, and the CSI report is at least one of periodic CSI report, semi-periodic CSI report or semi-static CSI report. Alternatively, the location information is included in a CSI report transmitted by the user equipment to the base station, and the CSI report only includes the location information. Alternatively, the location information is included in an RS transmitted by the user equipment to the base station.

In various methods described above in connection with FIGS. 9A to 9C, the parameters of the RIS can be adaptively adjusted according to the user's location, thereby reducing the loss of near-field performance and enhancing the signal gain.

### <Hardware Structure>

Additionally, the block diagrams used in the illustration of the above implementations show blocks in units of functions. Such functional blocks (structural units) are implemented by any combination of hardware and/or software. In addition, the implementing means for respective functional blocks is not particularly limited. That is, respective functional blocks can be implemented by one physically and/or logically combined device, or can be implemented by directly and/or indirectly connecting (e.g., by wire and/or wireless) two or more devices that are physically and/or logically separated.

For example, an electronic equipment according to an embodiment of the present disclosure can function as a computer performing the processing of the information transmitting method of the present disclosure. FIG. 10 is a schematic diagram of a hardware structure of an involved equipment 1000 (electronic equipment) according to an embodiment of the present disclosure. The above equipment 1000 (first network element) can be composed as a computer device that physically includes a processor 1010, a memory 1020, a storage 1030, a communication device 1040, an input device 1050, an output device 1060, a bus 1070, etc.

Additionally, in the following illustration, word such as “device” can be replaced by circuit, equipment, unit, etc. The hardware structure of the electronic equipment may include respective devices shown in one or more drawings, or may not include some of the devices.

For example, only one processor 1010 is illustrated, but there may be multiple processors. In addition, the processing may be performed by one processor, or by more than one processor concurrently, sequentially, or by other methods. Additionally, the processor 1010 may be installed by means of more than one chip.

For example, respective functions of the equipment 1000 is implemented by: reading a specified software (program) onto hardware such as the processor 1010, the memory 1020 and the like, so that the processor 1010 performs operations, controls communication by the communication device 1040, and controls reading and/or writing of data in the memory 1020 and the storage 1030.

For example, the processor 1010 drives an operating system to operate to control the computer as a whole. The processor 1010 may be composed of a Central Processing Unit (CPU) including interfaces with peripheral devices, control devices, arithmetic devices, registers, etc. For example, such control units described above can be implemented by the processor 1010.

In addition, the processor 1010 reads out programs (program codes), software modules, data, and/or the like from the storage 1030 and/or the communication device 1040 to the memory 1020, and performs various processing according to them. As a program, a program that causes the computer to execute at least a part of the actions illustrated in the above-described implementations can be adopted. For example, the processing unit of the first network element can be implemented by a control program saved in the memory 1020 and operated by the processor 1010, and other functional blocks can be implemented in the same way.

The memory 1020 is a computer-readable recording medium, which can be composed of at least one of, for example, a Read Only Memory (ROM), an Erasable Programmable ROM (EPROM), an Electrically EPROM (EEPROM), a Random Access Memory (RAM), and other appropriate storage media. The memory 1020 can also be referred to as a register, a cache, a main memory (main storage device), etc. The memory 1020 may save executable programs (program codes), software modules, and/or the like for implementing the method involved in an implementation of the present disclosure.

The storage 1030 is a computer-readable recording medium, which can be composed of, for example, a flexible disk, a floppy disk, a magneto-optical disk (e.g., a compact disc ROM (CD-ROM), etc.), a digital versatile disc, a Blu-ray® disc, a removable disk, a hard disk drive, a smart card, a flash memory device (e.g., a card, a stick, a key driver), a magnetic stripe, a database, a server, and other appropriate storage media. The storage 1030 can also be referred to as a secondary storage device.

The communication device 1040 is a hardware (transmitting and receiving device) for communication between computers through wired and/or wireless networks, which is also referred to as, for example, a network equipment, a network controller, a network card, a communication module, etc. In order to implement, for example, Frequency Division Duplex (FDD) and/or Time Division Duplex (TDD), the communication device 1040 may include a high-frequency switch, a duplexer, a filter, a frequency synthesizer etc. For example, the above-described transmitting unit, receiving unit, and/or the like can be implemented by the communication device 1040.

The input device 1050 is an input equipment (e.g., a keyboard, a mouse, a microphone, a switch, a button, a sensor, etc.) that accepts input from the outside. The output device 1060 is an output equipment (e.g., a display, a speaker, a Light Emitting Diode (LED) lamp, etc.) that realizes output to the outside. Additionally, the input device 1050 and the output device 1060 may also be an integrated structure (e.g., a touch panel).

In addition, respective devices such as the processor 1010, the memory 1020 and/or the like are connected through the bus 1070 for communicating information. The bus 1070 may be composed of either a single bus, or different buses among devices.

In addition, the electronic equipment may include a hardware such as a microprocessor, a Digital Signal Processor (DSP), an application specific integrated circuit (ASIC), a Programmable Logic Device (PLD), a Field Programmable Gate Array (FPGA) and/or the like, by which part or all of respective functional blocks can be implemented. For example, the processor 1010 may be installed by means of at least one piece of such hardware.

### (Variation)

Additionally, terms illustrated in the specification and/or terms required to understand the specification can be interchanged with terms with same or similar meanings. For example, a channel and/or symbol can also be a signal (signaling). In addition, a signal can also be a message. A reference signal can also be referred to as a Reference Signal (RS) for short, or can also be referred to as a Pilot, a pilot signal, and/or the like according to the applied standard. In addition, a Component Carrier (CC) can also be referred to as a cell, a frequency carrier, a carrier frequency, etc.

In addition, information, parameter, and/or the like illustrated in the specification can be expressed by an absolute value, or by a relative value with respect to a specified value, or by other corresponding information. For example, a radio resource can be indicated by a specified index. Further, a formula and/or the like using such parameters can be different from that explicitly disclosed in the specification.

Names used for parameters and/or the like in the specification are not restrictive in any aspect. For example, various channels (Physical Uplink Control Channel (PUCCH), Physical Downlink Control Channel (PDCCH), etc.) and information units can be identified by any appropriate names, thus these various names allocated to these various channels and information units are not restrictive in any aspect.

Information, signals, and/or the like illustrated in the specification can be expressed by any of a wide variety of different technologies. For example, data, command, instruction, information, signals, bits, symbols, chips, and/or the like that might be mentioned in all the above illustrations can be expressed by voltages, currents electromagnetic waves, magnetic fields or particles, optical fields or photons, or any combination thereof.

In addition, information, signals, and/or the like may be output from the upper layer to the lower layer and/or from the lower layer to the upper layer. Information, signals, and/or the like may be input or output via multiple network nodes.

The input or output information, signals, and/or the like may be saved in a specific place (e.g., memory) or managed by a management table. The input or output information, signals, and/or the like may be overwritten, updated or supplemented. The output information, signals, and/or the like may be deleted. The input information, signals, and/or the like may be sent to other devices.

The notification of information is not limited to the approaches/implementations illustrated in the specification, but can also be carried out by other methods. For example, the notification of information can be implemented by physical layer signaling (e.g., Downlink Control Information (DCI), Uplink Control Information (UCI)), upper layer signaling (e.g., Radio Resource Control (RRC) signaling, broadcast information (Master Information Block (MIB), System Information Block (SIB), etc.), Medium Access Control (MAC) signaling), other signals, or combinations thereof.

Additionally, physical layer signaling can also be referred to as L1/L2 (Layer 1/Layer 2) control information (L1/L2 control signal), L1 control information (L1 control signal) and so on. In addition, RRC signaling can also be referred to as RRC message, such as RRC Connection Setup message, RRC Connection Reconfiguration message, etc. Furthermore, the MAC signaling may be notified by a MAC Control Element (MAC CE), for example.

In addition, the notification of specified information (e.g., notification of “X”) is not limited to being carried out explicitly, but can also be carried out implicitly (e.g., by not notifying the specified information, or by notifying other information).

Determinations can be carried out by means of a value (0 or 1) represented by one bit, or by means of a Boolean value represented by true or false, or by means of a numerical comparison (e.g., comparison with a specified value).

Software, whether being referred to as software, firmware, middleware, microcode, hardware description language or some other name, should be broadly interpreted as referring to commands, command sets, codes, code segments, program codes, programs, subroutines, software modules, application programs, software application programs, software packages, routines, subroutines, objects, executable files, execution threads, steps, functions, etc.

In addition, software, commands, information, and/or the like can be sent or received via transmission medium. For example, when software is sent from websites, servers, or some other remote resources using wired technologies (coaxial cable, optical cable, twisted pair, Digital Subscriber Line (DSL), etc.) and/or wireless technologies (infrared, microwave, etc.), such wired technologies and/or wireless technologies are included in the definition of transmission medium.

Terms such as “system” and “network” used in the specification can be used interchangeably.

In the specification, terms such as Base Station (BS), wireless base station, eNB, gNB, cell, sector, cell group, carrier and component carrier can be used interchangeably. A base station is sometimes referred to as a fixed station, a NodeB, an eNB, an access point, a transmitting point, a receiving point, a femtocell, a small cell, etc.

A base station can accommodate one or more (e.g., three) cells (also referred to as sectors). When a base station accommodates multiple cells, the entire coverage area of the base station can be divided into multiple smaller areas, each of which can also provide communication services through a base station subsystem (e.g., an indoor small base station (Remote Radio Head, RRH)). A term such as “cell” or “sector” refers to a part or the whole of the coverage area of the base station and/or base station subsystem that provides communication services in the coverage.

In the specification, terms such as “MS (Mobile Station)”, “user terminal”, “UE (User Equipment)” and “terminal” can be used interchangeably. A mobile station is sometimes referred to by those skilled in the art as a subscriber station, a mobile unit, a subscriber unit, a wireless unit, a remote unit, a mobile equipment, a wireless equipment, a wireless communication equipment, a remote equipment, a mobile subscriber station, an access terminal, a mobile terminal, a wireless terminal, a remote terminal, a handset, a user agent, a mobile client, a client or some other appropriate term.

In addition, wireless base station in the specification can also be replaced by user terminal. For example, the various approaches/implementations of the present disclosure can also be applied to a structure in which a communication between a wireless base station and a user terminal is replaced by a communication among multiple user terminals (Device-to-Device, D2D). At this time, the functions embodied by the above-described electronic equipment can be regarded as the functions embodied by the user terminal. In addition, words such as “uplink” and “downlink” can also be replaced by “side”. For example, “uplink channel” can also be replaced by “side channel”.

Similarly, user terminal in the specification can also be replaced by wireless base station. At this time, the functions embodied by the user terminal can be regarded as the functions embodied by a first communication equipment or a second communication equipment.

In the specification, it is assumed that a specific action carried out by a base station is sometimes carried out by its upper node as appropriate. Obviously, in a network composed of one or more network nodes with a base station, a wide variety of actions carried out for communications with terminals can be performed by a base station, more than one network node except for the base station (e.g., Mobility Management Entity (MME), Serving-Gateway (S-GW), and/or the like, can be taken into account, but not limited to this), or combinations thereof.

The various approaches/implementations illustrated in the specification can be used alone or in combination, or can also be used by switching during execution. In addition, the orders in the processing steps, sequences, flowcharts, and/or the like of the various approaches/implementations illustrated in the specification can be changed as long as there is no contradiction. For example, with respect to the method illustrated in the specification, a wide variety of step units are given in an exemplary order, which are not limited to the specific order given.

The various approaches/implementations illustrated in the specification can be applied to systems and/or next-generation systems extended based thereon with Long Term Evolution (LTE), LTE-Advanced (LTE-A), LTE-Beyond (LTE-B), super 3^{rd} generation mobile communication system (SUPER 3G), international mobile communication-Advanced (IMT-Advanced), 4^{th} generation mobile communication system (4G), 5^{th} generation mobile communication system (5G), Future Radio Access (FRA), New Radio Access Technology (New-RAT), New Radio (NR), New Radio Access (NX), Future generation radio access (FX), Global System for Mobile Communications (GSM®), Code Division Multiple Access 3000 (CDMA3000), Ultra Mobile Broadband (UMB), IEEE 920.11 (Wi-Fi®), IEEE 920.16 (WiMAX®), IEEE 920.20, Ultra-WideBand (UWB), Bluetooth®, other appropriate wireless communication methods.

The recitations such as “according to” used in the specification does not mean “only according to” unless explicitly recited as such in other paragraphs. In other words, the recitations such as “according to” refers to both “only according to” and “at least according to”.

Any reference to units with ordinal numerals such as “first” and “second” used in the specification does not comprehensively limit the number or order of these units. Such names can be used in the specification as a convenient way to distinguish two or more units. Therefore, the reference to a first unit and a second unit does not mean that only two units can be adopted or that the first unit must precede the second unit in some way.

Terms such as “judging (determining)” used in the specification sometimes includes various actions. For example, “judging (determining)” can refer to calculating, computing, processing, deriving, investigating, looking up (e.g., searching in a table, a database or some other data structure), ascertaining, etc. In addition, “judging (determining)” can also refer to receiving (e.g., receiving information), transmitting (e.g., transmitting information), input, output, accessing (e.g., accessing data in memory), etc. In addition, “judging (determining)” can also refer to resolving, selecting, choosing, establishing, comparing, etc. That is, “judging (determining)” can refer to several actions.

Terms such as “connected” and “coupled” used in the specification or any variation thereof refer to any direct or indirect connection or combination among two or more units, which may include a case in which there are one or more intermediate unit between two units that are “connected” or “combined” with each other. The combination or connection among units can be physical, logical or a combination of both. For example, “connected” can also be replaced by “accessed”. As used in the specification, it can be considered that two units are “connected” or “combined” with each other by using one or more wires, cables, and/or printed electrical connections, and as some non-restrictive and non-exhaustive examples, by using electromagnetic energy with a wavelength of a radio frequency region, a microwave region, and/or a light (both visible and invisible) region, etc.

As used in the specification or claims, terms such as “including”, “comprising” and variations thereof, as well as the term “having”, are equally open. Further, the term “or” used in the specification or claims is not exclusive-or.

The present disclosure has been described in detail above, but it is obvious to those skilled in the art that the present disclosure is not limited to the implementations illustrated in the specification. The present disclosure can be implemented as modification and alteration thereto without departing from the purpose and scope of the present disclosure determined by the recitations of the claims. Therefore, the recitations of the specification is for the purpose of illustration and does not have any restrictive significance to the present disclosure.

1. A base station, comprising:
a control unit configured to determine configuration information regarding a reconfigurable surface device based on location of a user equipment; and
a transmitting unit configured to transmit the configuration information to the reconfigurable surface device so that the reconfigurable surface device determines a codebook used by the reconfigurable surface device based on the configuration information.

2. The base station according to claim 1, wherein the configuration information includes at least one of: information associated with operating mode of the reconfigurable surface device, information associated with codebook of the reconfigurable surface device, and information associated with how the reconfigurable surface device uses the codebook.

3. The base station according to claim 1, wherein the transmitting unit is further configured to transmit to the reconfigurable surface device control information including information of a time period corresponding to codewords associated with the codebook.

4. The base station according to claim 1, wherein the transmitting unit is further configured to:
transmit the configuration information to the reconfigurable surface device through an IP interface or an Xn interface; or
transmit the configuration information to the reconfigurable surface device through a wireless interface.

5. A reconfigurable surface device, comprising:
a receiving unit configured to receive configuration information associated with location of a user equipment from a base station;
a control unit configured to determine a codebook used by the reconfigurable surface device based on the configuration information, wherein the codebook is associated with array element state of a reconfigurable panel; and
the reconfigurable panel configured to reflect or transmit a message sent by the base station to the user equipment.

6. The reconfigurable surface device according to claim 5, wherein the reconfigurable surface device further comprises a transmitting unit further configured to feed back to the base station a configuration response message indicating a configuration success or configuration failure.

7. The reconfigurable surface device according to claim 6, wherein the transmitting unit is further configured to:
report information related to type of the reconfigurable surface device to the base station in the RRC procedure, and
transmit information required for initial access to the user equipment in the case that the reconfigurable surface device is a base station type.

8. The reconfigurable surface device according to claim 6, wherein the configuration information associated with the location of the user equipment is received through a downlink channel, and the configuration response message is sent through an uplink channel.

9. A user equipment (UE), comprising:
a control unit configured to acquire location information of the UE;
a transmitting unit configured to transmit the location information to a base station;
a receiving unit configured to receive a UE-specific message,
wherein the UE-specific message is emitted by the base station to a reconfigurable surface device and reflected or transmitted by the reconfigurable surface device to the UE.

10. The user equipment according to claim 9, wherein,
the location information is included in a CSI report transmitted by the user equipment to the base station, wherein the CSI report is at least one of periodic CSI report, semi-periodic CSI report or semi-static CSI report; or
the location information is included in a CSI report transmitted by the user equipment to the base station, wherein the CSI report only includes the location information; or
the location information is included in an RS transmitted by the user equipment to the base station.
